(19) United States
(12) Patent Application Publication
(10) Pub. No.: US 2025/0061442 A1
(43) Pub. Date: Feb. 20, 2025

(54) METHOD

(71) Applicant: TOYOTA JIDOSHA KABUSHIKI KAISHA, Toyota-shi (JP)

(72) Inventors: Yasunori NANYA, Nagoya-shi (JP); Yuzo YAMADA, Nagoya-shi (JP)

(73) Assignee: TOYOTA JIDOSHA KABUSHIKI KAISHA, Toyota-shi (JP)

(21) Appl. No.: 18/762,046

(22) Filed: Jul. 2, 2024

(30) Foreign Application Priority Data
Aug. 17, 2023 (JP) 2023-133113

(51) Int. Cl. G06Q 20/34; G06Q 20/28

(52) U.S. Cl. CPC G06Q 20/342; G06Q 20/28

(57) ABSTRACT

The terminal device storing the application program transmits a usage application for the postpaid settlement method. Next, the terminal device registers the postpaid settlement method issued in response to the usage application in the application program as one of the first settlement method available for the electronic settlement. When the terminal device registers the prepaid settlement method as one of the first settlement method in the application program, the terminal device automatically registers the postpaid settlement method in the application program as one of the second settlement method for depositing the prepaid settlement method registered as one of the first settlement method.

### CROSS-REFERENCE TO RELATED APPLICATION

This application claims priority to Japanese Patent Application No. 2023-133113 filed on Aug. 17, 2023, incorporated herein by reference in its entirety.

### BACKGROUND

### 1. Technical Field

The present disclosure relates to a terminal device and a storage medium.

### 2. Description of Related Art

Conventionally, an application program (hereinafter referred to as “payment application”) that is capable of registering a plurality of settlement methods, such as credit cards, prepaid cards, and so forth, has been known. A user can use any settlement method registered in advance in the payment application, when performing electronic settlement in participating shops. For example, WO 2014/155664 discloses that, when a user makes a usage application for a credit card, during credit examination, a prepaid card can be used, and payment methods can be switched between a prepaid card and a credit card in response to the user applying for switching.

### SUMMARY

There has been room for improvement in technology of payment applications.

In view of such circumstances, it is an object of the present disclosure to improve technology of settlement applications.

A method according to an embodiment of the present disclosure is a method executed by a terminal device storing an application program, the method including
transmitting a usage application for a postpaid settlement method,
registering the postpaid settlement method issued in response to the usage application in the application program, as one of first settlement methods available for electronic settlement, and
when registering a prepaid settlement method as one of the first settlement methods in the application program, automatically registering, in the application program, the postpaid settlement method as one of second settlement methods for depositing to the prepaid settlement method registered as one of the first settlement methods.

A storage medium according to an embodiment of the present disclosure stores a program that causes
a terminal device to execute
transmitting a usage application for a postpaid settlement method,
registering the postpaid settlement method issued in response to the usage application in the application program, as one of first settlement methods available for electronic settlement, and
when registering a prepaid settlement method as one of the first settlement methods in the application program, automatically registering, in the application program, the postpaid settlement method as one of second settlement methods for depositing to the prepaid settlement method registered as one of the first settlement methods.

According to an embodiment of the present disclosure, technology of settlement applications is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a terminal device;

FIG. 3 is a diagram illustrating a schematic configuration of an information processing device; and

FIG. 4 is a flowchart illustrating an operation of the terminal device.

### DETAILED DESCRIPTION OF EMBODIMENTS

Hereinafter, an embodiment of the present disclosure will be described.

### Outline of Embodiment

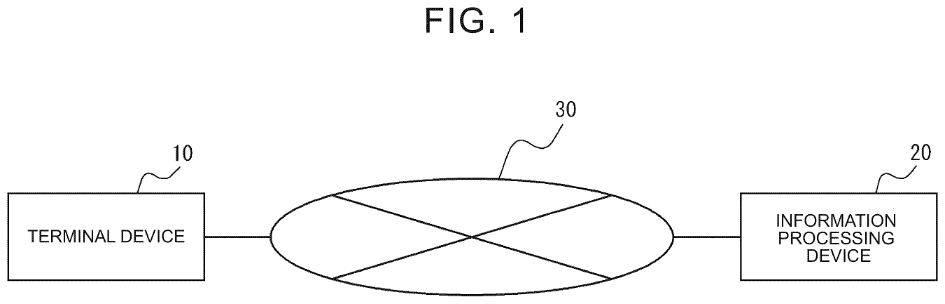

The outline of a system 1 according to an embodiment of the present disclosure will be described with reference to FIG. 1. The system 1 includes a plurality of terminal devices 10 and an information processing device 20. Each of the terminal devices 10 and the information processing device 20 is communicably connected to a network 30 including, for example, the Internet and a mobile communication network.

The terminal device 10 is, for example, a Personal Computer (PC), a smart phone, or a computer such as a tablet terminal. In the present embodiment, the terminal device 10 is installed with an application program, for example, a payment application, and is used by a user who uses the application program. Note that the payment application may be pre-installed, or may be downloaded and installed from a predetermined distribution server.

The information processing device 20 is, for example, a computer such as a server apparatus. The information processing device 20 is capable of communicating with a plurality of terminal devices 10 via the network 30.

First, the outline of the present embodiment will be described, and the details will be described later. The terminal device 10 storing the application program transmits a usage application for the postpaid settlement method. Next, the terminal device 10 registers the postpaid settlement method issued in response to the usage application in the application program as one of the first settlement method available for the electronic settlement. Then, when the prepaid settlement method is registered as one of the first settlement methods in the application program, the terminal device 10 automatically registers the postpaid settlement method in the application program as one of the second settlement methods for depositing the prepaid settlement method registered as one of the first settlement methods.

The user can use an arbitrary settlement method registered in advance in the payment application of the terminal device when performing the electronic settlement in the member store. However, for example, in a case where a prepaid settlement method such as a prepaid card is registered in a payment application and used for electronic settlement at a member store, conventionally, it is necessary for a user to separately register another settlement method (for example, a funding source) for depositing (charging) the prepaid settlement method, and thus the procedure becomes complicated. On the other hand, according to the present embodiment, when the prepaid settlement method (for example, the prepaid card) is registered as one of the first settlement method in the payment application, the postpaid settlement method is automatically registered as the second settlement method (for example, the funding source) for depositing the prepaid settlement method, so that the registration procedure of the settlement method can be simplified. Therefore, according to the present embodiment, the technology of the settlement application is improved in that the procedure when the user registers the settlement method in the settlement application can be simplified.

Next, each configuration of the system 1 will be described in detail.

### Configuration of Terminal Device

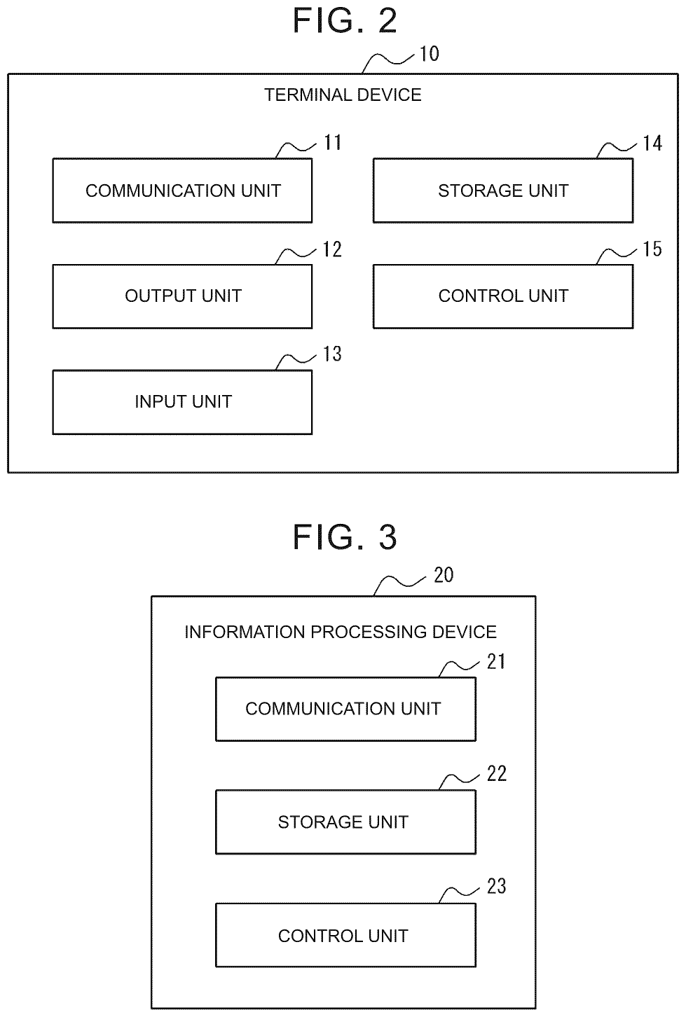

As illustrated in FIG. 2, the terminal device 10 includes a communication unit 11, an output unit 12, an input unit 13, a storage unit 14, a control unit 15, and a positioning unit 16.

The communication unit 11 includes one or more communication interfaces connected to the network 40. The communication interfaces correspond to mobile communication standards such as 4th Generation (4G) or 5th Generation (5G), but are not limited thereto. In the present embodiment, the terminal device 10 communicates with the information processing device 20 via the communication unit 11 and the network 30.

The output unit 12 includes one or more output devices for outputting information. The output device is, for example, a display that outputs information by video, a speaker that outputs information by sound, or the like, but is not limited thereto. Alternatively, the output unit 12 may include an interface for connecting an external output device.

The input unit 13 includes one or more input devices that detect an input operation by a user. The input device is, for example, a physical key, a capacitive key, a mouse, a touch panel, a touch screen integrally provided with a display of the output unit 12, a microphone, or the like, but is not limited thereto. Alternatively, the input unit 13 may include an interface for connecting an external input device.

The storage unit 14 includes one or more memories. The memories are, for example, a semiconductor memory, a magnetic memory, or an optical memory, but are not limited to these memories. Each memory included in the storage unit 14 may function as, for example, a main storage device, an auxiliary storage device, or a cache memory. The storage unit 14 stores any information used for the operation of the terminal device 10. For example, the storage unit 14 may store a system program, an application program such as a payment application, and embedded software. For example, the information stored in the storage unit 14 may be updatable by, for example, information acquired from the network 40 via the communication unit 11.

The control unit 15 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose processor specialized for a particular process. The programmable circuitry is, for example, but not limited to, Field-Programmable Gate Array (FPGA). The dedicated circuitry is, for example, but not limited to, Application Specific Integrated Circuit (ASIC). The control unit 15 controls the operation of the terminal device 10 as a whole.

### Configuration of Information Processing Device

As shown in FIG. 3, the information processing device 20 includes a communication unit 21, a storage unit 22, and a control unit 23.

The communication unit 21 includes one or more communication interfaces connected to the network 30. The communication interfaces correspond to, for example, a mobile communication standard, a wired Local Area Network (LAN) standard, or a radio LAN standard, but are not limited thereto, and may correspond to any communication standard. In the present embodiment, the information processing device 20 communicates with the plurality of terminal devices 10 via the communication unit 21 and the network 30.

The storage unit 22 includes one or more memories. Each memory included in the storage unit 22 may function as, for example, a main storage device, an auxiliary storage device, or a cache memory. The storage unit 22 stores any information used for the operation of the information processing device 20. For example, the storage unit 22 may store a system program, an application program, embedded software, a database, and the like. The information stored in the storage unit 22 may be updatable with information received from the network 30 via the communication unit 21, for example.

The control unit 23 includes one or more processors, one or more programmable circuits, one or more dedicated circuits, or a combination of these. The processor is a general-purpose processor such as a CPU or a GPU, or a dedicated processor specialized for a specific process, for example. However, the processor is not limited to these. The programmable circuit is, for example, an FPGA, but is not limited to this. The dedicated circuit is, for example, an ASIC, but is not limited to this. The control unit 23 controls the operation of the information processing device 20 as a whole.

### Operation Flow of the System 1

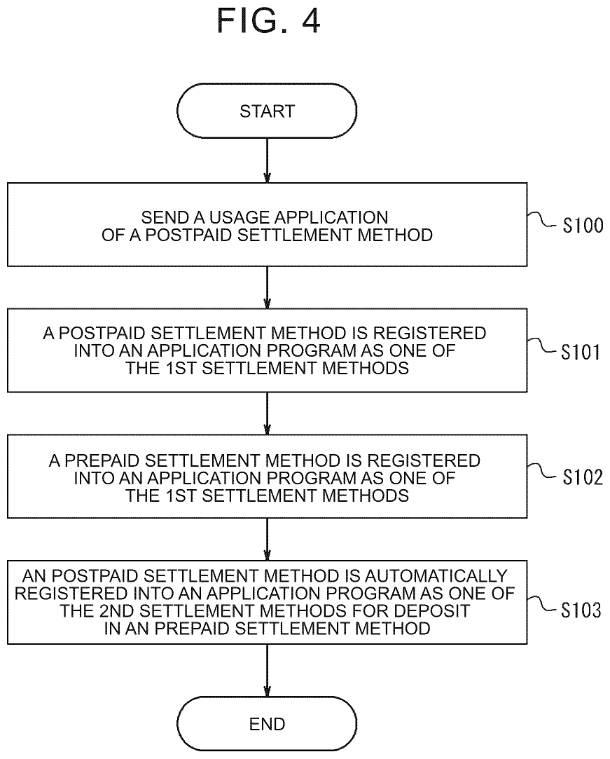

The operation of the terminal device 10 in the system 1 according to the present embodiment will be described with reference to FIG. 4.

S100: The control unit 15 of the terminal device 10 transmits a usage application for the postpaid settlement method.

Specifically, the user transmits the usage application of the postpaid settlement method using the terminal device 10 in which the application program is stored in the storage unit 14 of the terminal device 10. In the usage application of the postpaid settlement method, for example, information necessary for the usage application may be input to the user using the terminal device 10, but any input method not limited thereto may be adopted. When the input of the usage application of the postpaid settlement method by the user is completed, the control unit 15 transmits information necessary for the usage application to the information processing device 20 via the communication unit 11 and the network 30.

“Postpaid settlement methods” include any settlement method available for electronic settlements that make payments after receipt of goods or services, such as credit cards, virtual credit cards, postpaid electronic money, bill postpaid services, and carrier payments.

For example, the postpaid settlement method may be issued by a particular operator such as a “TOYOTA TS CUBIC CARD” or the like, or may be available for electronic settlement by the merchant. Further, for example, the first settlement method may be provided with an arbitrary feature such that the procedure can be simplified in a specific industry such as the automobile industry.

The “information necessary for the usage application” includes, but is not limited to, information necessary for the examination of the usage application, such as the approval of the terms, the name of the user, the certificate of the principal, and the like, and may include any information related to the usage application.

S101: The control unit 15 registers the postpaid settlement method issued in response to the usage application in the application program as one of the first settlement method available for electronic settlement.

Specifically, the control unit 23 of the information processing device 20 receives information necessary for a usage application from the terminal device 10 via the communication unit 21 and the network 30. Next, the control unit 23 examines whether to permit the use of the postpaid settlement method based on the information necessary for the usage application. Then, the control unit 23 transmits information on the examination result to the terminal device 10 via the communication unit 21 and the network 30.

Thereafter, the control unit 15 receives information related to the examination result from the information processing device 20 via the communication unit 11 and the network 30. Then, the control unit 15 determines whether or not the examination has passed on the basis of the information on the examination result. When it is determined that the examination has passed, the control unit 15 registers the application program as one of the first settlement method available for the electronic settlement.

The “first settlement method” includes any settlement method available for electronic settlement at a merchant via the application program. For example, the first settlement method may be the afore-mentioned postpaid settlement method, or may be the afore-mentioned prepaid settlement method, but is not limited thereto, and may be any settlement method.

The “information on the examination results” includes not only information that indicates the results of the examination, but also information that is required regarding the postpaid settlement method, such as the user ID and a unique number that the user uses when using the postpaid settlement method.

S102: The control unit 15 registers the prepaid settlement method as one of the first settlement methods in the application program.

Specifically, when the user selects the prepaid settlement method as one of the first settlement methods using the application program stored in the storage unit 14, the control unit 15 registers the prepaid settlement method as one of the first settlement methods in the application program. As a method for the user to select the prepaid settlement method as one of the first settlement method, for example, a screen of the terminal device 10 may be used to select the prepaid settlement method, but any input method not limited thereto may be adopted. Alternatively, the control unit 15 may automatically register the prepaid settlement method as one of the first settlement methods in the application program without requiring a user operation.

“Prepaid settlement methods” include securities issued on the basis of a price prepaid by a user, such as prepaid cards, virtual prepaid cards, gift cards, electronic money, and the like.

In the present embodiment, the postpaid settlement method and the prepaid settlement method are provided by the same business operator, but the present disclosure is not limited thereto.

When S103:S102 is performed, the control unit 15 automatically registers the postpaid settlement method in the application program as one of the second settlement methods for depositing the prepaid settlement method registered as one of the first settlement methods.

Specifically, when S102 is performed, the control unit 15 automatically registers the information of the prepaid settlement method, which is registered as one of the first settlement method stored in the storage unit 14, to the application program by storing in the storage unit 14 as one of the second settlement method for depositing the prepaid settlement method. The method of storing in the storage unit 14 as one of the second settlement method may be performed by setting the flag including a flag indicating whether or not to use it as the second settlement method in one of the information of the prepaid settlement method, or may be performed by storing the information of the prepaid settlement method registered as one of the first settlement method as it is as the settlement method registered as the second settlement method.

The “second settlement method” is, for example, a funding source, but is not limited thereto, and may include an arbitrary settlement method for depositing money to the prepaid settlement method.

As described above, the terminal device 10 storing the application program transmits a usage application for the postpaid settlement method. Next, the terminal device 10 registers the postpaid settlement method issued in response to the usage application in the application program as one of the first settlement method available for the electronic settlement. Then, when the prepaid settlement method is registered as one of the first settlement methods in the application program, the terminal device 10 automatically registers the postpaid settlement method in the application program as one of the second settlement methods for depositing the prepaid settlement method registered as one of the first settlement methods.

According to this configuration, when the prepaid settlement method provided by the first business operator is registered in the settlement application as one of the first settlement method, the postpaid settlement method is automatically registered as the second settlement method for depositing the prepaid settlement method, so that the registration procedure of the settlement method can be simplified. Therefore, according to the present embodiment, the technology of the settlement application is improved in that the procedure when the user registers the settlement method in the settlement application can be simplified.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the terminal device 10 may be distributed among a plurality of computers capable of communicating with each other. Further, for example, an embodiment in which some or all of the constituent elements of the terminal device 10 are provided in the information processing device 20 is also possible. For example, the information processing device 20 may include some or all of the constituent elements of the terminal device 10.

Further, for example, in the above-described embodiment, the terminal device 10 may display a GUI for accepting a user operation for making a usage application of the prepaid settlement method when the postpaid settlement method is registered in the application program as one of the first settlement method, and transmit the usage application of the prepaid settlement method in response to the user operation on GUI.

Specifically, the control unit 15 of the terminal device 10 displays a button for making a usage application of the prepaid settlement method on the registration completion screen displayed after S101. When the user presses the button, the control unit 15 transmits a usage application for the prepaid settlement method to the information processing device 20 via the communication unit 11 and the network 30. Note that GUI for accepting the user's manipulation for usage application of the prepaid settlement method is not limited to a button, and any GUI such as a message box or the like can be adopted. In addition, the screen displaying GUI for accepting the user's manipulation for making the usage application of the prepaid settlement method may be another screen instead of the registration completion screen.

For example, in the above-described embodiment, when the terminal device 10 registers the prepaid settlement method as one of the first settlement method in another application program, the postpaid settlement method may be automatically registered as one of the second settlement method in another application program.

Specifically, when the prepaid settlement method is registered as one of the first settlement methods in another application program different from the application program stored in the storage unit 14 of the terminal device 10, the control unit 15 of the terminal device 10 automatically registers the postpaid settlement method as one of the second settlement methods in another application program. The method of automatically registering in another application program may be performed by any method including, but not limited to, use of an API, sharing of a database of the application program stored in the storage unit 14, file sharing, use of a messaging protocol, or use of an authorization protocol such as OAuth or OpenID Connect, or a combination thereof.

Further, for example, in the above-described embodiment, the order of registration of the first settlement method and the second settlement method in the application program may be changed.

Specifically, the terminal device 10 transmits a usage application for the postpaid settlement method. Next, the terminal device 10 registers the prepaid settlement method as one of the first settlement method in the application program, and registers the postpaid settlement method issued in response to the usage application in the application program as one of the second settlement method for depositing the prepaid settlement method registered as one of the first settlement method. Then, when the terminal device 10 registers the postpaid settlement method as one of the second settlement method in the application program, it automatically registers the postpaid settlement method as one of the first settlement method in the application program.

Further, an embodiment is also possible in which, for example, a general-purpose computer functions as the terminal device 10 according to the above embodiments. Specifically, a program describing processing contents for realizing each function of the terminal device 10 according to the above embodiments is stored in the memory (storage medium) of the general-purpose computer, and the program is read and executed by the processor. Therefore, the present disclosure can also be realized as a program that can be executed by the processor or a non-transitory computer-readable medium that stores the program. The non-transitory computer-readable medium is an example of a storage medium.

What is claimed is:

1. A method executed by a terminal device storing an application program, the method comprising:
transmitting a usage application for a postpaid settlement method;
registering the postpaid settlement method issued in response to the usage application in the application program, as one of first settlement methods available for electronic settlement; and
when registering a prepaid settlement method as one of the first settlement methods in the application program, automatically registering, in the application program, the postpaid settlement method as one of second settlement methods for depositing to the prepaid settlement method registered as one of the first settlement methods.

2. The method according to claim 1, wherein the postpaid settlement method is a prepaid card.

3. The method according to claim 1, further comprising when registering a prepaid settlement method in another application program as one of the first settlement methods, automatically registering, in the other application program, the postpaid settlement method as one of the second settlement methods.

4. The method according to claim 1, further comprising:
when registering the postpaid settlement method in the application program as one of the first settlement methods, displaying on a screen a graphical user interface which accepts user operations for performing usage application for the prepaid settlement method; and
transmitting the usage application for the prepaid settlement method, in accordance with user operations performed on the graphical user interface.

5. A non-transitory storage medium storing a program that causes a terminal device storing an application program to execute:
transmitting a usage application for a postpaid settlement method;
registering the postpaid settlement method issued in response to the usage application in the application program, as one of first settlement methods available for electronic settlement; and
when registering a prepaid settlement method as one of the first settlement methods in the application program, automatically registering, in the application program, the postpaid settlement method as one of second settlement methods for depositing to the prepaid settlement method registered as one of the first settlement methods.
